(19) United States
(12) Patent Application Publication
(10) Pub. No.: US 2003/0086521 A1
(43) Pub. Date: May 8, 2003

(54) Rosary electronic apparatus to count Muslim or non-Muslim prayers/recitations

(76) Inventor: Irshad A. Rana, Fremont, CA (US)

Correspondence Address: IRSHAD A. RANA, 43686 SKYE ROAD, FREMONT, CA, 94539, US

(21) Appl. No.: 10/045,275

(22) Filed: Nov. 7, 2001

(51) Int. Cl. G06M 3/00

(52) U.S. Cl. 377/3

(57) ABSTRACT

An electronic hand held rosary apparatus with beads counting digital mechanism and storing such counts of various Muslim/non-Muslim prayers/recitations in separately identifiable registers (with keys or vocal means). The goal is to facilitate the worshipper in knowing the specific counts of prayers made and therefore derive gratification in doing the correct religious worship/meditation.

### BACKGROUND OF THE INVENTION

1) Field of Invention

This invention relates to an apparatus for counting the beads of a conventional type rosary (Muslim or non-Muslim), also known as “tusbeeh” in Urdu. The invention attempts to maintain the traditional touch of bead counting during the process of performing various praiseworthy recitations of God and enabling the believer/worshipper to know the exact counts via digital microprocessor technology.

2) Description of Related Art

Muslim and most other religions advise their followers to recite specific words (called “zaiker” in Arabic) in a specific number of times containing praises for the Almighty God (Allah, Lord etc.) in an attempt to reflect the meaning of the same on one's self and help purify the soul as a result. The counts for such prayers (recitations) are kept either via rosary beads for personal counting or clay tablets, grains of corn, wheat etc for a congregation type setting. The most predominant means for counting, on a personal basis, are the beaded rosaries containing varying numbers of beads, usually 100 or multiple of 100's. The rosary beads are normally punctuated with an oversize bead at an interval of 33, 33 and then end point is reached after 34 additional beads. When the recitations are in several hundreds or even thousands, then it can become confusing for worshipper to count the multiples of 100's. In the event the rosary is large containing several hundred beads, the accuracy of large counts is improved but the rosary becomes difficult to handle and not conveniently portable.

### OBJECTIVE AND SUMMARY OF INVENTION

The objective of the invention is to facilitate precise counting of Muslim/non-Muslim religious recitations of prayers and meditative words (mantras) resulting in substantially improved gratification for the believer.

The invention provides a convenient, portable, microprocessor based digital apparatus to perform the said counting.

Microprocessor based technology, for personal or congregation use, offers the advantages of low cost, versatility and digital accuracy in counting the worshipper's prayers/recitations. The alphanumeric visual display is to be facilitated with LED (light emitting diode) light to read displays in darkness.

The apparatus housing may be of any number of configurations as long as it is pocketsize and offers the believer a convenient portability and ease of use at any place/time. The preferred embodiment is envisaged a crescent shaped plastic housing containing stringed beads, bead sensor, microprocessor, programmable read-only memory and random access memory along with the necessary battery and keys to carry out functions of storing and retrieving the counts of prayers/recitations from the storage registers.

Special feature of the display is to consist of liquid crystals, alphanumeric with a LED light to view display in darkness. The apparatus is to include a buzzer capable of emitting a short sound after each count of 33 in each storage register. The buzzer sound is to be a bit longer when the count of 100 is reached.

The apparatus for congregation use will be similar to the personal one except that it will have a radio transmitter means to beam the alphanumeric data to a nearby receiver/display (RD) unit, which will add the counts from various congregation members to the respective memory registers and display the contents for the congregation members to see and share.

### BRIEF DESCRIPTION OF DRAWINGS

The preferred embodiment of the present invention can be best explained and understood with the presentation of attached drawings, wherein:

FIG. 1 represents front view of an embodiment of the apparatus of the present invention

FIG. 2 represents the microprocessor and the main electronic hardware components

FIG. 3 represents view of funnel shaped bead receiver fitted with a bead sensor

FIG. 4 represents view of radio receiver alphanumeric display device

FIG. 5 represents the end view of the invention embodiment (in direction of the arrow shown)

### DETAILED DESCRIPTION OF THE PREFERRED EMBODIMENT

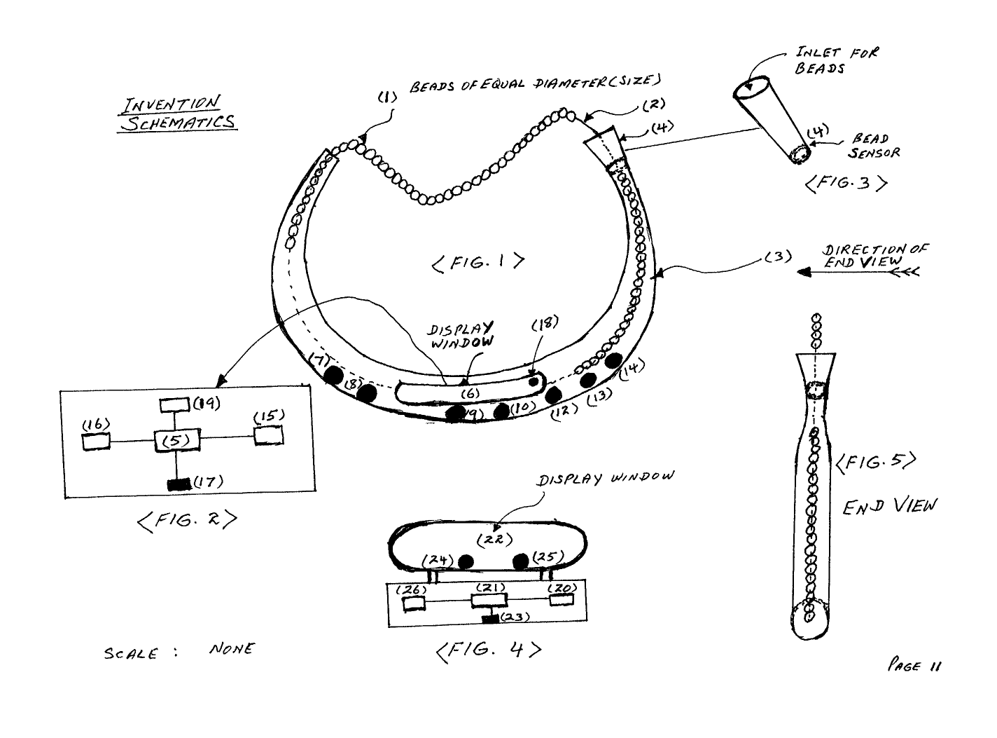

FIG. 1 shows the apparatus of the present invention as a pocketsize, crescent shaped, plastic housing containing the threaded beads and electronic hardware represented in FIG. 2. The hardware consists of 8-bit microprocessor (5), which addresses some 8 kilobytes of an erasable, programmable, read only memory (EPROM—(15)), some hundreds bytes of a random access memory (RAM—(16)), electromagnetic or optical bead sensor, a liquid crystal alphanumerical video display (6) of two rows of thirty characters and piezoelectric buzzer. The power supply of the device is provided by storage batteries or accumulator (17), for a value of 6 volts and 60 milliampere. A lighting means (18) would provide illumination in the dark to check the alphanumeric displays.

The housing is so configured with means that the beaded string can be pulled out only in one direction, say clockwise in this case.

As an alternate (variant) to electromagnetic or optical bead sensor, a microprocessor (5) controlled spool designed to rotate in one direction and generating an electrical pulse when moved equivalent to advancing of one bead out of the housing. The bead string would be wound on the spool and as the believer would pull it out, the spool would generate pulses equal to the number of beads that have exited the housing. The believer would thus ensure he (she) recites enough prayers to count all the beads that are out side the housing.

This personal bead counting apparatus would be converted to a congregation type function (second variant) whereby the prayers from individuals participating in a group (congregation) would be accumulated with all the members of the congregation by means of radio transmitter and receiver. A radio transmitter means (19) in FIG. 2 would be connected to the microprocessor (5) with means and capability to send the alphanumeric data to a nearby radio receiver (see FIG. 4)

The radio receiver (20) would be housed in an apparatus (FIG. 4) and connected with microprocessor means (21), random access memory—RAM (26), battery means (23), and alphanumeric display means (22) The liquid crystal alphanumeric video display of two rows by 50 characters would be large enough in dimensions to be legible to congregation members from about 50-100 ft.

The programming of the apparatus will be done using an appropriate software language. The number of registers programmed could be any number (say 10 in this case) and each register capable of accumulating a count as large as one million. For a congregation type device, similarly the number of memory registers could vary. Also, the radio receiver apparatus (FIG. 4) would have the same number of memory registers as the transmitter and the total number of congregation members who could send data to the receiver could also vary (say as high as 100 or more) and the apparatus would be programmed accordingly.

Microprocessor (5) controls a number of keys, the function of which are described below with reference to FIGS. 1, 2, and 3:

Key marked “register” and noted as (7) in FIG. 1 is designated to activate a memory storage register. After turning the device on, pressing of register key would activate No 1 Register in the memory bank. Repeat pressing of this key would turn on the next register in the memory in series, say from 1 to 10 in this case.

Key marked “alphabet” and noted as (8) in FIG. 1 can be used to name a given memory register for storing the prayer iterations. Each pressing of this key would present the next English alphabet for possible entry to name the register. If No 1 register is to be named “suba”, you would press the alphabet key until the letter “s” appear and then you would press enter key. Next you would repeat the same process for letters u, b & a. Thus the memory Register No 1 is now named “suba” for recording the counts of prayers.

Key marked “reset” and noted as (9) in FIG. 1 can be used to reset the current memory register with no name and zero counts resident in memory. Repeat pressing of this key could clear all registers of names and counts

Key marked “on/off” and noted as (10) in FIG. 1 is to be used to turn the device on and off. Turning the device off would not clear memory register of counts and register names if any given. The memory clearing could be done only with the reset button or key.

No 11 is unused in this narration

Key marked “enter” and noted as (12) in FIG. 1 is to be used to enter alphabets during the naming of memory register, if the option of naming is used.

Key marked “forward” and noted as (13) in FIG. 1 can be used to scroll the memory registers forward to check the counts

Key marked “backward” and noted as (14) in FIG. 1 can be used to scroll the memory registers backward to check the counts

Key marked “on/off” and noted as (24) in FIG. 4 is to be used to turn the apparatus on or off for the congregation type prayer counting

Key marked “reset” and noted as (25) in FIG. 4 is used to reset the current register of counts and names. Repeat pressing of reset key would clear all registers of names and counts.

Given hereunder are three scenarios for the use of preprogrammed apparatus to count prayers:

Scenario 1

A worshipper (believer) is using a personal apparatus to count prayers without naming the registers. God's praise is to be recited 100 times; 33 times “subha nullah—ie God is magnificent”, 33 times “alhumdo lillah—ie all praises are for God”, 34 times “Allah ho Akbar—ie God is great” He (she) would carry out the following steps to do the counting:

Turn the device on by pressing the key marked “on/off” (10). The device would turn on and show a pulsating star

Press the key marked “register” (7) and the number 1 would appear with pulsating “=” sign, as “1=” in the display window (6). Pulsating sign signify the current memory register is active and bead counting can proceed.

Pull the stringed beads out clockwise and begin the first prayer. With each prayer, drop a bead in the funnel shaped inlet. As the bead would drop through the annular bead sensor (4) a number would appear after the equal sign, say 1, 2, 3, 4, . . . 33. Once this number is reached, a short buzzer would sound and the display would show “1=33”

Press the key marked “register” (7) again. In addition to “1=33”, the display window would show “2=” with pulsating “=” sign.

Pull beaded string clockwise some more and begin the second prayer “Alhumdo lillah”. With each drop of bead corresponding to the prayer, the counts in register 2 would start accumulating until there is a buzzer after 33 counts. Now the display window would show: 1=33, 2=33.

Press the key marked “register” (7) again. In addition to 1=33, 2=33 the display window would also show 3=with “=” sign pulsating.

Pull beaded string clockwise some more and begin the third prayer “Allah ho Akbar”. With each drop of bead corresponding to the prayer, the counts in register 3 would start accumulating until there is a buzzer after 33 counts and one additional drop of bead would counting. Upon completion of 100 prayers the display window would show “1=suba=33, 2=alhm=33, 3=akbr=34”

Scenario 3

This covers a congregation type scenario. The electronic rosary (tusbeeh) is designed for the congregation type setting with a built in radio transmitter to beam the alphanumeric data to a nearby receiver for display and visual observation by the attendees. Assume a total of 50 persons participate in the prayer ceremony and each recites 33 counts of “subha nullah”, 33 counts of “alhumdo lillah” and 34 counts of “Allah ho Akbar”. Assume the radio receiver and display units has been programmed to accept alphanumeric data from up to 100 electronic tusbeehs. The prayers would proceeds as follows:

A prayer leader would announce that three prayer recitations are to carried out by each member and name the prayers as mentioned above.

The leader would turn the receiver/display (RD) unit on and place it in a prominent position to facilitate visibility to the participants. Further, using his electronic tusbeeh (ET) he would name the three memory registers using the procedure described under Scenario 2 above. As soon as the registers are named, the alphanumeric display would show it on the receiver/display unit. The registers would show no counts.

Using the key marked “backward” the leader would scroll to the first memory register. This will be indicated by the pulsating sign “=”. At this point the leader would announce the apparatus is ready for receiving prayer counts from the members.

Each of the 50 congregation members would press the key marked “register” and commence prayers counting into Register # 1. Since different members will be reciting at different rates the counts will be accumulating in registers as received. If certain data are received simultaneously from multiple members, the microprocessor (21) software of receiver/display (RD) unit would queue it up until it is added to the respective memory register and displayed. After the congregation members complete all prayers, the display unit should indicate: 1=suba=1650, 2=alhm=1650, 3=akbr=1700.

A different embodiment of the apparatus is possible (not represented) whereby vocally naming of the registers therein are provided, by endowing the hardware/software disclosed in FIGS. 1-4 with vocal synthesizers means that would vocally recite registers (names) and the numerical counts stored in each vocally named registers.

The combination of two embodiments (variants) with display and acoustical features controlled by microprocessors are also envisaged.

In summary, an apparatus has been realized based on digital microprocessor technology to enhance the religious experience and gratification of Muslim/Non-Muslim believers (worshippers). Also, this invention is in synchrony with the modern technological developments and fit for a generation who are so adept with the electronic gadgets.

The invention described herein has been disclosed with reference to preferred embodiments. It is to be expressly recognized that variations, additions and/or omissions can be made thereto, without departing from protective scope, as defined by the appended claims.

### LIST OF NUMERALS

(1): magnetic or nonmagnetic beads

(2): plastic thread

(3): pocket size plastic housing

(4): Bead Sensor

(5): Microprocessor in electronic rosary (tusbeeh)

(6) Display window in electronic tusbeeh

(7) Register Key

(8) Alphabet Key

(9) Reset Key

(10) On/off Key

(11) Unused

(12) Enter Key

(13) Backward Scroll Key

(14) Forward Scroll Key

(15) An Erasable Programmable Read-only Memory (EPROM)

(16) Random Access Memory (RAM)

(17) Battery

(18) Lighting Switch

(19) Radio Transmitter

(20) Radio Receiver

(21) Microprocessor in Receiver/Display (RD) Unit

(22) Alphanumeric Display Window in RD Unit

(23) Battery (power) in RD Unit

(24) On/Off Key in RD Unit

(25) Reset Key in RD Unit

(26) Random Access Memory (RAM) in RD Unit

I claim:

1) A rosary electronic apparatus (tusbeeh) to count Muslim, non-Muslim prayers comprising:
Beads (1), magnetic or nonmagnetic of any configuration, means of counting Muslim prayer iterations one at a time. The beads being threaded on a plastic thread (2).
Crescent shaped or any configuration housing (3) to contain the threaded beads either on a spool or without it. The threaded beads to move only in one direction (say clockwise).
Electromagnetic means of sensing the magnetic rosary beads (wound on a plastic thread) as they would fall through an annular opening containing an electromagnetic coil situated near the base of a funnel shaped part (4) in the housing of the apparatus and generate an electronic pulse.

2) An apparatus according to claim 1, wherein optical means of sensing the nonmagnetic rosary beads as they would fall through an annular opening containing an optical sensor to generate an electrical pulse

3) An apparatus according to the claim 1, wherein the threaded rosary beads (nonmagnetic) are wound on a spool (unidirectional) capable of generating an electrical pulse when each bead is advanced by one count and exit out of the housing.

4) Microprocessor means (5) for counting the electronic pulse generated by the sensor (s) under claim 1, 2 and 3, storing into a number of separate registers and display means (6) to show the counts of various (recitations/mantras) as believer (worshipper) will use: key (7) named “register” to activate a memory storage register, alphabet entry key (8) named “alphabet”, reset key (9) named “reset”, on/off key (10) named “on/off”, enter key (12) named “enter”, forward scroll key (13) named “forward” or an arrow mark, backward scroll key (14) named “backward” or an arrow mark

5) An apparatus according to claims 1, 2, 3, and 4 further comprising an erasable programmable read-only memory (15); and a random access memory (16) and said memories being functionally connected to microprocessor means (5) along with bead sensor, keys and battery.

6) An apparatus according to claim 5, further comprising: at least one battery means (17) for storing and providing power to the microprocessor means (5)

7) An apparatus according to claim 6, further comprising; switch means (10) for turning power on and off from the battery means to the microprocessor means (5).

8) An apparatus according to claim 7, further comprising; a lighting means (18) to illuminate liquid crystal display means (6) in darkness by depressing a key

9) The apparatus according to claim 8, wherein: the said display means (6) is video-type display

10) The apparatus according to claim 9, wherein: the said video-type display is alphanumeric

11) The apparatus according to claim 9, wherein: the said video-type display (6) is a liquid crystal

12) The apparatus according to claim 9, wherein: the said microprocessor means (5) includes a buzzer

13) The apparatus according to claim 9, wherein: the said microprocessor means (5) includes a radio transmitter (19) of a given frequency to send counting results to a nearby receiver.

14) The apparatus according to claim 13, wherein: a corresponding frequency radio receiver (20) will receive digital alphanumeric counts from the radio transmitter with a microprocessor means (21) and display the same counts on a larger alphanumeric display device (22) for a congregation type setting.

15) The apparatus according to claim 14, wherein: microprocessor means (21) is functionally connected to a random access memory—RAM (26), radio receiver (20), alphanumeric liquid crystal display means (22), battery means (23) to supply power to microprocessor, key (24) to turn device on/off and key (25) to reset the operations.

16) The apparatus according to claims 4, 5, 13, 14 and 15 above, wherein: the registers are named (identified) using digital vocal recording means functionally connected to the microprocessor means (5) and (21) and the so named registers would declare content of counts vocally (speech synthesizer means) at a given time interval or by pressing the on/off key of apparatuses in FIG. 1 and FIG, 4.
